(19) United States
(12) Patent Application Publication
(10) Pub. No.: US 2002/0080257 A1
(43) Pub. Date: Jun. 27, 2002

(54) Focus control system and process

(76) Inventor: Benjamin Blank, Los Angeles, CA (US)

Correspondence Address: Ted R. Rittmaster, Foley & Lardner, Suite 3500, 2029 Century Park East, Los Angeles, CA, 90067-3021, US

(21) Appl. No.: 09/964,254

(22) Filed: Sep. 26, 2001

Related U.S. Application Data
(60) Provisional application No. 60/235,724, filed on Sep. 27, 2000.

(51) Int. Cl. H04N 5/232

(52) U.S. Cl. 348/345

(57) ABSTRACT

The system employs hardware and software that enable a user to adjust the focal point, and focus of a motion picture, digital movie camera, still digital camera (includes all uses, including sound), or other image recording apparatus, by providing a field of view analogous to the camera's field of view. When this field of view is displayed on a touch screen or other suitable user interactive display device, a user may provide input to control camera aim and/or selects a distance finding mechanism, drive the lens to the correct focal length based on preset preferences and thereby bring the image into a desired “focus.”

### RELATED APPLICATION

The present invention relates to U.S. Provisional Patent Application No. 60/235,724, which is incorporated herein by reference and from which priority is claimed.

### BACKGROUND

1. Field of the Invention

The present invention relates, generally, to systems and processes for recording images and, in particular embodiments, to systems and processes for controlling and focussing a camera, for example, during image recording events.

2. Related Art

Refocusing a motion picture and/or video camera can be a difficult and arduous task when coupled with the other necessities of shooting. In the motion picture industry, professional focus pullers are often employed to determine the distance of a subject from the camera and then to manually change the focal length of the lens based on the determined distance. The difficulty of pulling focus can be further compounded when shooting hand held (when the camera is held by hand) and/or when the camera is located on a crane or jib. There is a need in the industry for systems or processes that provide focus pullers or other technicians with the ability to simplify the task of camera focussing, and/or improve accuracy, flexibility, and creativity.

Owners and operators of professional, consumer and prosumer camera products would benefit from such systems and process. Thus, in addition to the demand for such products in the professional market, there is a similar demand for systems and processes for increasing accuracy and ease of use of consumer or prosumer products.

There are various systems currently on the market and/or patented devices that are capable of automatically refocusing a camera. There are also systems that redirect camera position by way of a remote system, such as a touch screen, and automatically focus the camera on a subject by using a center weighted or matrixed compromise of the scene (where the focus is taken from the center of the lens. For example, U.S. Pat. Nos. 5,396,287 and 4,720,805 each describe systems for re-directing a camera position via a user interface, such as a touchscreen, as further exemplified by U.S. Pat. No. 5,729,249. However, the systems described in those patents do not allow the ability to change focal subjects within a composed scene. Also, there are systems that provide the ability to track a target (e.g., as described in U.S. Pat. No. 4,286,289) and still cameras that provide automatic focussing functions, but again, such systems are center wighted (focus is taken from the center of the lens) or are quadrant systems in which the lens area is dvided into four quadrants which the user may designate.

As described in more detail below, embodiments of the present invention diverge from such systems, by allowing any subject within the camera frame to be brought into focus, regardless of camera position and regardless of whether or not the subject is centered in the camera's frame or is moving within or through the camera's frame. A real-time image may be displayed on a user screen to provide the user with the ability to monitor the image in the camera frame and select any part of that image for focus control. Programmable features may be provided for allowing custom specifications and more precise control of the recorded image. As a result, embodiments of the present invention provide a greater level of flexibility of focus control and, thus, a can enhance accuracy and creativity, for example, in the motion picture recording industry and the commercial and promercial camera industry.

### BRIEF DESCRIPTION OF THE DRAWINGS

Referring now to the drawings in which like reference numbers represent corresponding parts throughout:

FIG. 1 is a block diagram representation of a focus control system, according to an embodiment of the present invention.

FIG. 2 is a perspective view of a system in operation, according to an embodiment of the invention.

FIG. 3 is screen view of display on a user interface, according to an embodiment of the present invention.

### DETAILED DESCRIPTION OF PREFERRED EMBODIMENTS

The following detailed description is of the best presently contemplated mode of implementing the invention. This description is not to be taken in a limiting sense, but is made merely for the purpose of illustrating the general principles of embodiments of the invention. The scope of the invention is best defined by the appended claims.

The present invention relates, generally, to systems and processes for recording images and, in particular embodiments to systems and processes for controlling and focussing a camera during image recording events. As discussed above, embodiments of the present invention are particulary useful in addressing present needs in the motion picture industry and in the consumer or prosumer camera industry. However, it will be understood that prinicples of the invention are applicable to other image recording contexts and, thus, further embodiments of the invention relate to image recording systems and processes outside of the motion picture and consumer or prosumer camera industries.

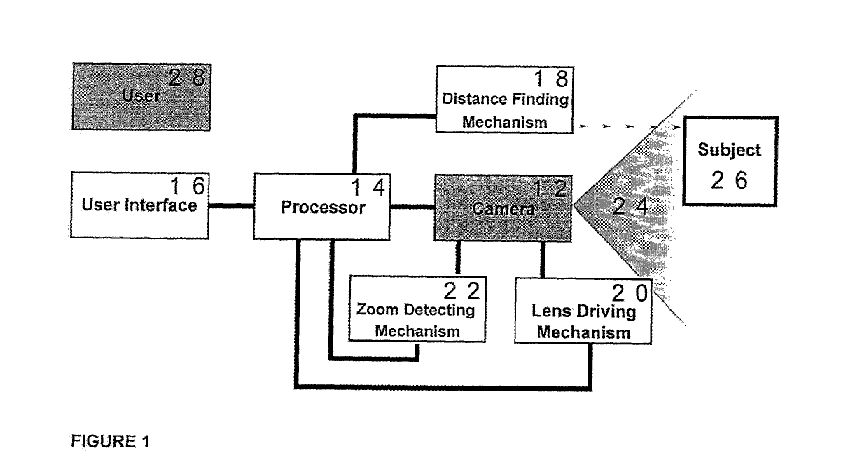

FIG. 1 shows a block diagram representation of a system 10 according to an embodiment of the present invention. The system 10 in FIG. 1 is configured to operate with an image recording mechanism or camera 12. The system 10 includes a processor 14 connected for communication with a user interface 16, a distance finding mechanism 18 and a lens driving mechanism 20. The processor 14 also may be connected for communication with the camera 12, for example, to receive image information from the camera 12. In systems which operate with cameras that have zoom funtions, a zoom detecting mechanism 22 may be connected for communication with the processor 14. The various connections between the processor 14 and other system elements and the camera 12 may be made with one or combination of suitable electrical conductors, including, but not limited to wires, cables or the like, or wireless connection means including, but not limited to optical links, electromagnetic links or other suitable wireless communicaiton links.

In one embodiment, the system 10 is configured to operate with a conventional, preexisting camera. In further embodiments, the system 10 is configured with the camera 12 as a system component. In one preferred embodiment, the camera 12 comprises a professional motion picture camera for recording live action images on a recording medium, such as film or a digital recording medium. In other embodiments, the camera 12 may comprise a video camera designed for consumer or prosumer use. In yet other embodiments, the camera 12 may comprise other suitable image recording mechanisms.

The camera 12 has a field of view 24 in which one or more subjects, such as a subject 26, may be located. The lens driving mechanism 20 of the system 10 may be operatively connected to the camera 12, to drive the lens of the camera 12, for example, to focus on a selected subject 26 within the camera's field of view, in accordance with lens driving signals received from the processor 14. In addition, the zoom detecting mechanism 22 may be operatively connected to the camera 12, to detect the zoom postion of the camera lens and provide zoom position signals to the processor 14.

The processor 14 functions to monitor and provide information and instructions to various components of the system. The processor 14 may comprise any suitable processing device programmed or otherwise configured to perform functions described herein. For example, the processor 14 may comprise a programable general purpose computer, such as the processor or processors in a standard laptop computer, desktop computer or the like, programmed to perform functions described herein. In other embodiments, the processor 14 may comprise a dedicated processor, programmed or otherwise configured to provide system functions. Also, while the drawing shows a single box for processor 14, it will be understood that the functions described herein for processor 14 may be distributed among and carried out by multiple processors.

The user interface 16 includes a user input device for receiving input from a user 28 and providing the processor 14 with information corresponding to the user's imput. For example, such user input information may comprise a user's selection of a subject or area 26 within the field of view 24. As described in more detail below, the user interface 16 may comprise any suitable user input device, including, but not limited to a keyboard, touchscreen, joy stick operator, mouse or other cursor control operator, other user operators, or combinations thereof, capable of allowing a user to select a subject or area 26 within the field of view.

In preferred embodiments, the user interface 16 includes a user display for displaying an image of the camera's field of view 24, to assist the user's selection of a subject or area 26 in the field of view. In such embodiments, the processor 14 is connected to receive image information, such as live video feed or prerecorded image information, from the camera 12, for example, from the video tape recorder VTR output or other usitable connection to the camera. The processor 14 provides corresponding video or image information to the user interface 16 for displaying the image in the camera's field of view 24. The user interface 16 may also provide a mechanism for allowing a user to select or adjust one or more parameters, image capture and effects, that enable the user to further control the focal point of the image shown.

The distance finding mechanism 18 is positioned to detect the distance of subjects within the field of view relative to the mechanism 18 and/or the camera 12. Upon receiving a user's selection of a subject or area 26 through the user interface, the processor 14 directs the distance finding mechanism 18 to determine the distance of the selected subject 26. In response, the distance finding mechanism 18 produces and provides a distance signal to the processor 14, based on the detected distance of a selected subject 26.

As described in more detail below, by employing the user interface 16, the user 28 may select a subject 26 within the camera's field of view 24 and cause the lens driving mechanism 20 to drive the focus of the cameral lens, based on the distance of the selected subject 26 from the camera lens. In this manner, the camera lens may be focused on any subject within the field of view 24, regardless of the location of the subject within the field of view. Accordingly, the camera 12 may focus onto the subject 26, even when the subject 26 is not centered within the field of view of the camera. Moreover, in embodiments in which the user interface 16 has a display device, the user 28 may readily select a subject 26, change subjects 26 and follow moving subjects 26, to cause the camera to correspondingly focus onto a selected subject, change focus to other selected subjects or maintain the focus on an object moving through the field of view. In addition, other functions and advantages provided by embodiments of the system 10 are described below.

In one example embodiment, the user interface 16 includes a display device and a pointing device such as a stylus or a cursor controller. By employing the pointing device, the user 28 may point to a location on the image displayed on the display device of the user interface 16. When the user selects any subject or area within the image, a signal corresponding to the location on the image of the selected subject or area is sent to the processor 12. A control signal is then sent from the processor to the distance finding mechanism 18 to cause the mechanism 18 to determine the distance of the selected subject or area. In preferred embodiments, the task of processing the user's input and determining the distance of the selected subject or area is carried out with minimal delay (for example, within one or a few milliseconds).

The distance finding mechanism 18 provides the processor 14 with distance information corresponding to the determined distance of the selected subject or area. The processor 14 employs the distance information, in conjunction with preset parameters chosen by the user, and determines a focus setting for the camera, based on the distance information and preset parameters. The processor 14 sends a signal to the lens driving mechanism 20, for controlling the focal length of the lens, to bring the chosen subject or area into the desired state of focus.

The distance finding mechanism 18 may comprise any suitable apparatus for determining an accurate distance from subject to the focal plane. This may be accomplished by providing the processor 14 with a signal representing the distance between the distance finding mechanism 18 and the subject 26 and allowing the processor 14 to calculate the distance between the camera 12 and the subject 26, from a pre-known distance (if any) between the distance finding mechanism 18 and the camera 12. Alternatively, the distance finding mechanism 18 may be provided with suitable processing means to calculate the distance between the subject 26 and the camera 12.

Example distance finding mechanisms 18 include, but are not limited to, devices employing laser, infrared, sonar or practical distance measurers, e.g. a transducer. The distance frnding mechanism 16, and/or its beam, is aimable, in that it can be directed to the target subject or area, via a gimbal, stepper motor, turntable, servo, solenoid, mirror and/or other means of directing or aiming.

The distance finding mechanism 18 may be aimed or directed anywhere within the field of view 24 of the camera 12, independent of the aim or direction of the camera. As a result, the aim or direction at which the distance finding mechanism may be moved, for example, to follow a subject 26 that is moving through the field of view 24 or to change from one subject to another within a field of view 24, while the camera 12 remains stationary or moves at a different rate or in a different direction.

In preferred embodiments, the function of determining the distance of the selected subject or area, including aiming of the distance finding mechanism 18 is carried out with relatively high precision and speed, and with minimal noise. The distance finding mechanism 18 may be mounted on the camera body, attached to the camera lens, contained within the camera body or located separate from the camera. By predefining or calculating the distance between the distance finding mechanism 18 and the camera lens, the distance signal provided by the distance finding mechanism may be used to derive the distance between the camera lens and the selected subject or area 26, and, thus, determine a desired focal length for cameral lens.

As discussed above, image information may be provided to the display device of the user interface 16, by connecting the processor 14 to the video output tap or jack, for example, a video tape recorder VTR tap, of the camera 12. In other embodiments, the image information may be obtained by other suitable connection of the processor to the camera 12. In yet further embodiments, the camera 12 or other suitable recording or storage device, may store pre-recorded image information and provide such pre-recorded image information to the processor 14. Pre-recorded images can be utilized, for example, in instances where visual effects are being shot.

In one preferred embodiment, a live image feed from the VTR tap (or other suitable output terminal) in a motion picture camera is sent to the user interface 16 via the processor 14. A corresponding image is displayed on the display device of the user interface 16, to facilitate the user's selection of one or more focal points within the camera's field of view 24 and, in some embodiments, beyond the image being recorded by the camera. For example, the field of view 24 may include a recordable image frame, where the field of view extends a small distance beyond the image frame in the x and y coordinate directions. Alternatively, or in addition, a second camera may be positioned to provide an image including, but extending in the x and y axis directions beyond, the scene recorded by the first camera 12.

The user interface 16 may be integrated with the processor 14 as a unit, for example, as the keyboard and/or touch screen display device of a laptop computer or other portable communication device that contains the processor 14. Alternatively, the user interface 16 may be configured separate from the processor 14. In embodiments in which the user interface 16 comprises a touch screen display, the screen may display the image sent by the live or pre-recorded image feed received by the processor 14 from the camera 12 or other suitable device. A matrix of x,y coordinates on the screen are associated with the various positions that the distance finding mechanism 18 can assume. For example, the distance finding mechanism may aim a distance finding beam at any subject or area within the field of view 24 that the user selects by selecting the corresponding position of the subject or area on the touch sensitive screen. Position selection on the screen can be achieved by finger, stylus and any other means of touching or pointing to discrete locations on the screen. Alternate selection devices can also be used such as, but not limited to, a cursor, mouse, trackpad, joystick etc.

Once the subject 26 has been selected, the distance finding mechanism 18 is directed toward the subject position, and calculates the distance to the subject. The distance information is then provided to the processor 14. In some embodiments, the processor 14 provides data to the display device of the user interface 16, to display distance inforamation associated with the selected subject 26, for example as a digital read-out. The processor also provides data to the lens driving mechanism 20, based on the distance information received from the distance finding mechanism 18. In this manner, the lens driving mechanism 20 adjusts the focal length of the camera lens in accordance with the data from the processor 14 and, thus, in accordance with the distance information and any preset or user-customized paramters or settings. In preferred embodiments, the task of adjusting the focal length is carried out with minimal delay (for example, within one or a few milliseconds).

As a representative example, the subject 26 may be moving within or through the field of view 24 of the camera 12 and changing its distance relative to the camera 12 (i.e., changing focal planes of the camera 12) as it moves. For example, if the camera is filming a car driving down a winding road, the display device of the user interface 16 displays a real time image of the car on the road within the camera's field of view 24. By following the car or specific area on the car with the selector on the user interface, the distance finding mechanism 18 is controlled to determine distance of the car, as the car moves along the road.

Based on the determined distance and any further preset or user-selected parameters, the lens driving mechanism 20 is controled to drive the lens to the appropriate focus position. As a result, the car or specific area on the car selected by the user may be maintained in a desired degree (or varying degrees) of focus, as the car moves within the camera's field of view and changes focal length relative to the camera. Further embodiments of the system 10 may include tools, such as target tracking tools, for helping to maintaining a desired focus on a moving object, such as the car in the above example, even if the user is not able to continually stay with the subject, for example, if the subject's movements are erratic and unpredictable.

The lens driving mechanism 20 may comprise any suitable device capable of changing the focal length of the camera 12. In preferred embodiments, the lens driving mechanism 20 may be esily disengaged from the camera 12, to allow an operator to hand pull focus, as desired. Many conventional cameras already include motors which adjust focal length. In embodiments in which an existing camera motor is used to adjust focal length, the processor 14 may be connected to control the existing camera motor, either directly or through a separate motor control mechanism (instead of the lens driving mechanism 20 in FIG. 1).

Embodiments involving zoom and/or macro-photography may employ the zoom detecting mechanism 22 and parameters programmed in the processor 14, for example as factory presets, user settings made through the interface 16 or the like. The zoom detecting mechanism 18 may comprise any suitable device capable of determining the focal length (mm) of the lens, e.g. as it zooms from its minimum to maximum zoom, for example, from 60 mm to a 120 mm. In some contexts, it may be desirable to give the distance finding mechanism 18 a new frame of reference via the processor. This is especially true if the distance finding mechanism 18 is not integrated in the lens.

For example, if the camera is filming a house using a 40-120 mm zoom and the camera is located 100 yards from the house, then at a 40 mm zoom, the side of the house fills the frame (viewable image). At that zoom setting, the beam of the distance finding mechanism 18 will have to move a certain distance from the center of the frame, to take a reading from the right side of the house. If the operator changes the zoom to creating a new focal length of 80 mm, the distance that the distance finding mechanism beam must move to reach the right side of the house is reduced an amount proportional to the difference in focal lengths between the previous setting (40 mm) and the new setting (80 mm). In preferred embodiments, the processor 14 is programmed or otherwise configured to determine a new frame of reference for the distance finding mechanism 18, in response to a change in (or otherwise dependent upon) the zoom angle, as detected by the zoom detecting mechanism 22.

Similarly, the processor may include memory containing preset reference frames for the various focal lengths of lenses. Thus, if a 50 mm lens is selected, the aim of the beam of the distance finding mechanism 18 will be calibrated for the selected lens. In further embodiments, the processor 14 may be programmed or otherwise configured to provide a new frame of reference for macro photography or extreme focus changing instances (for example, where an extremely shallow depth of focus and divergent focal landscape change dramatically). Such new frames of reference may be retrieved from memory associated with the processor 14 or derived from preset distance settings that approximate a new frame and/or an averaging algorithm which automatically discerns average distance of a subject or scene.

In many conventional digital and video cameras, zoom detection is determined by existing circuitry. In embodiments which employ such cameras, the processor 14 may be connected to obtain zoom detection information from the camera's existing circuitry, either directly or through a separate interface (instead of the zoom detecting mechanism 22 in FIG. 1). Alternatively, the zoom detecting mechanism 22 can be attached to the lens or body, or, integrated into the lens or body.

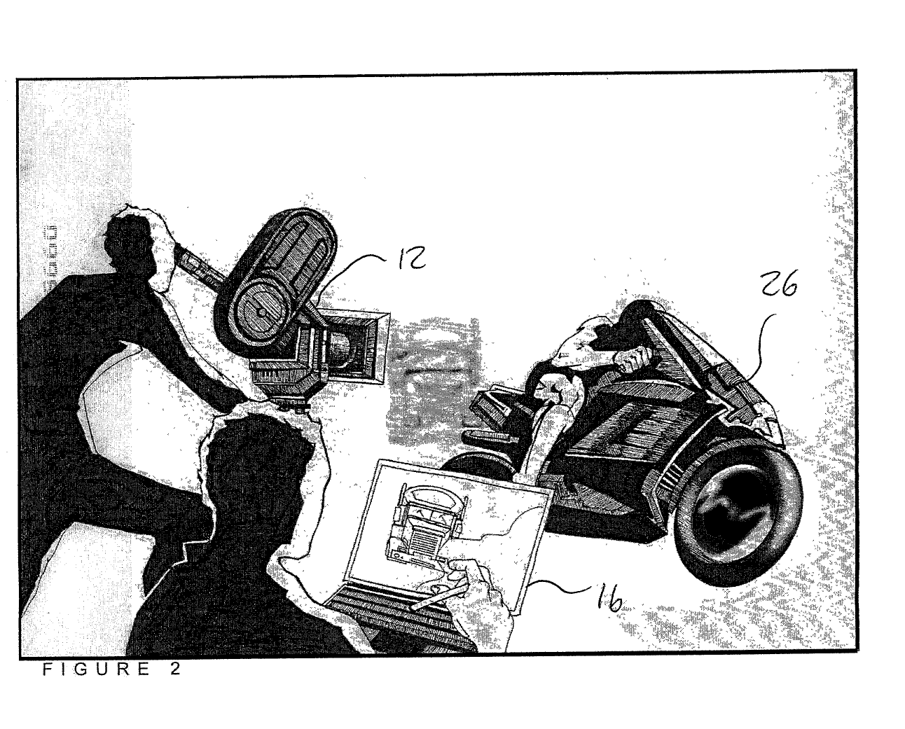

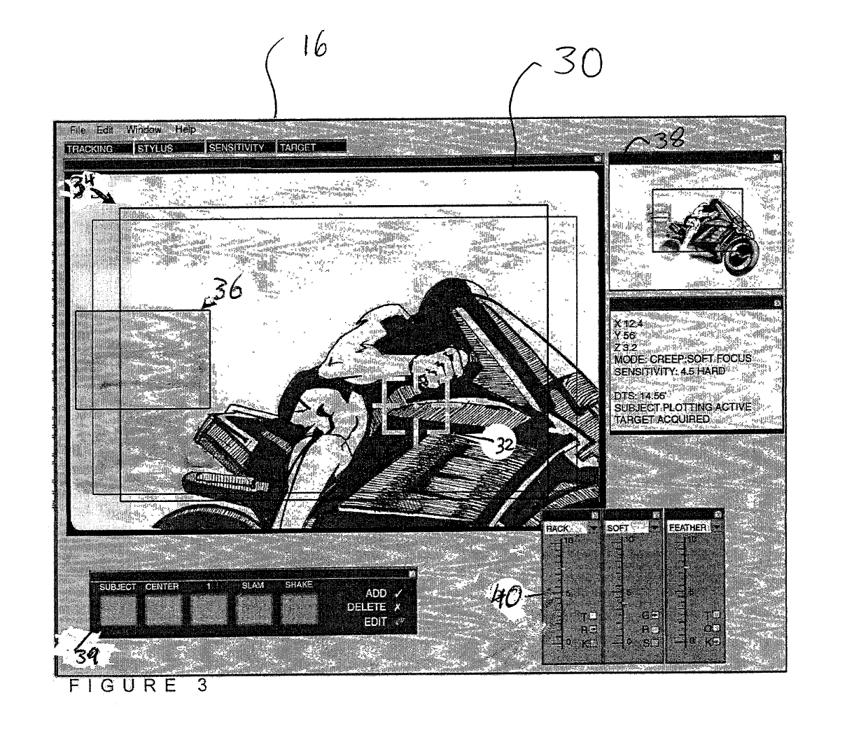

Various components of an embodiment of the system of FIG. 1 are shown in an example operation in FIG. 2, wherein the camera 12 comprises a motion picture camera, the user interface 16 comprises a keyboard and/or a graphical user interface GUI on the display device of a laptop computer and the subject 26 comprises a motorcycle moving through the recorded image frame of camera. A representative example embodiment of a GUI for the user interface 16 is shown in FIG. 3. As discussed above, in preferred embodiments the GUI displays the “real-time” camera feed, for example, in window 30. Once a target subject 26 is selected by a user, the display provides indicia, such as customizable crosshairs 32 or other suitable markings or text, to identify the selected focal point within the established recorded image frame 34. In preferred embodiments, the indicia (or crosshairs) change in size, shape, pulse, and/or other characteristics, depending on the mode in which the system is operating. Example modes are described below.

A target tracking system may also be implemented which will assist the user in remaining locked on a primary or secondary subject. In some embodiments, the system may have the ability to focus on one subject while tracking another. It may also have the ability to “memorize” the location of a subject (or otherwise determine the location of a subject) without having to continuously track the subject. In this instance, the head might conduct a quick scan of the scene thereby finding the subject whose attributes it has “remembered.” Thus, for example, once the user has selected a button (or other selector) on the GUI which the user had previously instructed the processor to recognize as “find truck in scene and bring a particular subject (for example the truck) into focus based on present or real-time focus parameters,” the processor will instruct the distance finding mechanism to find the subject (for example, truck) and continue to track the distance of the subject (truck) until further instructions are provided.

As a representative example, a target tracking system may be employed when the subject is moving fast or erratically, such as a fast and erratically moving car, shot with a very shallow focal length. In such an example, the car may move quickly to the left of frame at such speed that the user is not able to keep up with the motion. The tracking system is able to keep up with the motion. In one example, the target tracking system provides target boxes or other indicia 36 on the display showing active image plots that follow a moving subjects. By allowing a user to select target boxes, and in concert with programming profiles, a desired focus may be achieved. Indicia, such as crosshairs would move with the selected target subject. Pertinent information such as target distance, focal length, mode of operation, etc., may be displayed in an optional floating window on the user interface display.

As discussed above, in a further embodiment, a second camera (motion picture, video, digital etc) may be positioned on, in or near the primary camera 12, to provide an overview of the frame of the scene being recorded or to provide a view beyond one or more edges of the frame being recorded. The second camera may be connected to the processor 14 to provide a reference image, beyond the field of view of the primary camera 12, to allow a user to see and, thus, anticipate the location of subjects before they enter frame of the primary camera. In one example, the second camera provides a larger view and, thus, extends beyond all edges of the framed image, to warn the user of subjects encroaching the frame of the primary camera 12 from any direction, so that the user may achieve a desired focus on the subjects, before they enter the framed image. The larger view may be displayed in the window 30 or in a further window 38.

Below are examples of different features that may be employed, individually or in combination, in various embodiments of the system 10. In accordance with one example feature, the user may customize different focal points, for example, by selecting one or more (preferably a plurlity of) different ‘marks’ within the scene displayed on the user interface 16. The user may select such marks by, for example, touching or pointing to the image on the screen. Alternatively, one or more marks may be preprogramming, for ezample, as marks 1-N. Once marks are preprogrammed, the user may open a ‘mark’ window displayed on the user interface 16 and select a number 1-N or other indicia to select the associated preprogrammed mark. A mark may also be a focal mark in that a preset focal distance is implied by the mark, as well a spatial location.

As a further example feature, embodiments of the system 10 may employ multiple focus modes. Such focus modes may include a ‘feather focus’ mode, in which the user targets subjects that are within relatively close focal lengths. Thus, for example, a ‘feather mode’ may be implemented when a user has targeted portions of an actor's face and wants to toggle focus between the tip of the nose and eye. A ‘soft focus’ mode would cause a targeted subject to be slightly out of focus, for example, by adjusting the camera focal length slightly longer or slightly shorter than the focal length that otherwise corresponds to the subject's distance from the camera. In preferred embodiments, the amount that the camera focal length is adjusted long or short of the subject's actual distance is settable by the user, to allow continual and consistent soft focus on one or more subjects. A focal algorithm may be employed to determine a suitable focal length adjustment to achieve a user-selectable amount of soft focus.

A ‘creep or speed’ mode may be employed to allow a user to select the speed with which the focus is achieved (or racked). An ‘average’ mode may be employed, where the focal length is dependent upon the location of a plurality of subjects. In the ‘average’ mode, a suitable focal length can be derived by finding the distances of more than one (and, preferably, all) of the plurality of subjects and determining an average distances on which to base the focal length. A ‘shake’ mode may be employed to provide a focus “special effect” where the camera drifts in and out of focus at varying rates, intensities, and speeds as determined by the user.

Various parameter settings for the above modes may be made through the user interface 16. For example, the user interface 16 may include a GUI providing user selectable text, numbers, icons, virtual buttons, knobs, toggles or slide selectors 39 for selecting and controlling focus modes and parameters. Thus, with respect to the above example of focussing on portions of an actor's face, the speed with which the lens is ‘racked’ may be controlled by entering customized parameter information, or by selecting predefined values, sliding virtual toggles, or the like. In this manner, the system allows for a small shifts of focus between the eye and nose with the stylus, where the virtual toggle can be manipulated as if the User's hand was on the actual barrel of the lens, feathering the focus back and forth.

Virtual toggles 40 or other suitable selectors may be provided to the user as separate ‘windows’ within the GUI which allow the user to adjust at least one and, preferalby, all of the possible adjustable parameters within the system. In further embodiments, parameter settings may be memorized and new ‘modes’ or ‘effects’ may be created and memorized by the system. In further embodiments, preprogrammed user preferences may be created by adjusting effects, modes and sensitivity etc. of the various components of the system. In one preferred embodiment, one or more (and, preferably, all) modes, preferences, preprogrammed user preferences, marks, features, etc. can be activated by programming a custom stroke of a selector, e.g. the stylus, keyboard, voice, or designated action tab.

A further example feature may provide programmable, adjustable sensitivity to control how reactive the motor drive is to a sudden change in recorded focal length. For example, if the camera 12 is directed toward a boy on a swing and the user is targeting the boy's face as the subject 26, during part of the boy's swinging motion, the boy's foot may eclipse his face in the image produced by the camera. If it is not desired to have the focus jump to the boy's foot and back again, the user may select a suitable sensitivity on ‘Continual Focal Subjects’ versus ‘Jump Rack Focus.’

For example, to follow the motion of the boy's face in the above example, the user may touch a stylus or pointer pen to the screen and move the stylus or pen in a continuous motion back and forth in an arc on the screen, corresponding to the motion of the displayed image of the boy's face. By selecting a a continual focal subjects setting, the focus remains fixed on the boy's face and does not jump, when the boy's foot momentarily comes into frame. If the user wants to jump the focus to the boy's mother in the background, the user lifts the pen and touches on the mother character. In preferred embodiments, upon lifting and repositioning the stylus, pen (or other pointer) to another location, focus quickly racks to correspond to the new location.

The system 10 is preferably flexible enough to allow a user to adjust to the job at hand and, in some embodiments, allow the user to create custom settings for the various available functions, as discussed above. As a further example feature, the system may be customized such that tapping the stylus a present number of times (for example, twice) on a subject 26 can activate a number of features depending on what the user has selected this action to activate. For example, in one embodiment, the tapping action may activate any feature the user has selected for that action. In one representative example, the tapping action could activate the initiation of a continual focal subjects mode. Alterntively, the tapping action would inform the processor to find and focus on the boys foot and initiate a preset rack focus mode. In this manner, the system may provide the user with a host of preset functions and options, yet be adaptable to allow an experienced user the felxibility to customize the interface options.

Further example features include processor programming or configurations that allow a user to perform and/or view video playback, for example, to review a previously shot scene. Further example features include processor programming or configurations that allow the user to record script notes, reference numbers, camera rolls, sound rolls or the like, that, for example, may assist the camera department and/or a script supervisor. Yet further example features include pre-visualization software and files that may be loaded/imported into the system, for example, to aid in the filinmaking process by providing still or moving frames for reference and having the ability to increase or decrease the opacity of these images and overlay them as layer on the primary image recorded by the camera 12.

The foregoing description of the preferred embodiment of the invention has been presented for the purposes of illustration and description. It is not intended to be exhaustive or to limit the invention to the precise form disclosed. Many modifications and variations are possible in light of the above teaching.

What is claimed is:

1. A system for recording images, comprising:
a camera having an adjustable focus and a field of view defining an image frame having a frame center, the camera for recording an image within the image frame;
a focus adjuster operatively coupled to the camera, for adjusting the focus of the camera within a range of focal planes in the field of view of the camera;
a user interface for receiving user input information, including information associated with a user's selection of a location relative to the field of view of the camera;
a processor operatively coupled to the focus aduster and the user interface, for defining a focal plane within the field of view of the camera dependent on the user selected location and for controlling the focus adjuster to adjust the focus of the camera to the defined focal plane, independent of the position of the selected location relative to the center of the frame of the camera.

2. A system as recited in claim 1, further comprising a distance finding mechanism for determining the distance of the user selected location relative to the camera, wherein said processor is operatively coupled to the distance finding mechanism for determining a focal plane based on the distance of the user selected location relative to the camera.

3. A system as recited in claim 2, further comprising:
a zoom detection mechanism for detecting the zoom state of the camera;
wherein the distance finding mechanism includes a beam directable toward the user-selected location and wherein the processor is operatively coupled to the zoom detection mechanism and the distance finding mechanism for controlling the direction of the beam of the distance finding mechanism based on the detected zoom state of the camera.

4. A system as recited in claim 1, wherein the user-selected location comprises a location in a first focal plane and wherein the processor-defined focal plane is first focal plane.

5. A system as recited in claim 1, wherein:
the user input information further includes user-selected focal plane modifications;
the user-selected location comprises a location in a first focal plane;
the processor-defined focal plane comprises the first focal plane modified in accordance with the user-selected focal plane modifications;

6. A system as recited in claim 5, wherein the user-selected focal plane modifications comprise a modification of the focal plane a pre-set distance further than the focal plane of the user-selected location.

7. A system as recited in claim 5, wherein the user-selected focal plane modifications comprise a modification of the focal plane a user-selectable distance further than the focal plane of the user-selected location.

8. A system as recited in claim 5, wherein the user-selected focal plane modifications comprise a modification of the focal plane a preset distance closer than the focal plane of the user-selected location.

9. A system as recited in claim 5, wherein the user-selected focal plane modifications comprise a modification of the focal plane a user-selectable distance closer than the focal plane of the user-selected location.

10. A system as recited in claim 5, wherein the user-selected focal plane modifications comprise a selected speed at which the camera achieves a focus on the user-selected focal plane.

11. A system as recited in claim 5, wherein the user-selected focal plane modifications comprise a selected shake parameter at which the camera changes into and out of focus on the user-selected focal plane at a particular rate.

12. A system as recited in claim 11, wherein the user input information includes a user-specified shake rate.

13. A system as recited in claim 5, wherein the user input includes a plurality of user selected locations and wherein the user-selected focal plane modifications comprise a selected average mode, wherein the focal plane of the camera is adjusted to the average focal plane of the plurality of user selected locations.

14. A system as recited in claim 1, wherein the user interface includes a display device operatively coupled to display an image corresponding to the image frame of the camera;

15. A system as recited in claim 14, wherein the user interface comprises a touch screen display device.

16. A system as recited in claim 1, wherein the user interface comprises at least one of the group consisting of a touch screen, a keyboard, a mouse, and a joy stick.

17. A system as recited in claim 1, wherein the user interface includes a display device operatively coupled to display an image corresponding to the image frame of the camera and further includes selection means for allowing a user to select the user-selected location on an image frame displayed on the display device.

18. A system as recited in claim 17, wherein said selection means comprises a touch screen associated with the display device.

19. A system as recited in claim 17, wherein said selection means comprises a cursor control means associated with the display device, for allowing a user to control the location of a cursor on the image displayed on the display device.

20. A process for recording images, comprising:
recording an image frame within the field of view of a camera;
adjusting the focus of the camera to at least one focal plane within a range of focal planes in the field of view of the camera;
receiving user input information through a user interface, including information associated with a user's selection of a location relative to the field of view of the camera;
defining, with a processor, a focal plane within the field of view of the camera dependent on the user selected location; and
controlling, with the processor, the focus adjuster to adjust the focus of the camera to the defined focal plane, independent of the position of the selected location relative to the center of the frame of the camera.

21. A process as recited in claim 20, further comprising determining the distance of the user selected location relative to the camera with a distance finding mechanism, wherein said processor is operatively coupled to the distance finding mechanism for determining a focal plane based on the distance of the user selected location relative to the camera.

22. A process as recited in claim 21, further comprising:
detecting the zoom state of the camera;
controlling the direction of a beam of the distance finding mechanism based on the detected zoom state of the camera.

23. A process as recited in claim 20, further comprising receiving user-selected focal plane modifications through the user interface, wherein the user-selected location comprises a location in a first focal plane and wherein the processor-defined focal plane comprises the first focal plane modified in accordance with the user-selected focal plane modifications;

24. A process as recited in claim 23, wherein the user-selected focal plane modifications comprise a modification of the focal plane to a focal plane further than the focal plane of the user-selected location.

25. A process as recited in claim 23, wherein the user-selected focal plane modifications comprise a modification of the focal plane to a focal plane closer than the focal plane of the user-selected location.

26. A process as recited in claim 23, wherein the user-selected focal plane modifications comprise a selected speed at which the camera achieves a focus on the user-selected focal plane.

27. A process as recited in claim 23, wherein the user-selected focal plane modifications comprise a selected shake parameter at which the camera changes into and out of focus on the user-selected focal plane at a particular rate.

28. A process as recited in claim 23, wherein the user input includes a plurality of user selected locations and wherein the user-selected focal plane modifications comprise a selected average mode, wherein the focal plane of the camera is adjusted to the average focal plane of the plurality of user selected locations.

29. A process as recited in claim 20, further comprising displaying an image corresponding to the image frame of the camera on a display device associated with the user interface includes a display device operatively coupled to display an image corresponding to the image frame of the camera.
